(19) United States
(12) Patent Application Publication
(10) Pub. No.: US 2003/0152784 A1
(43) Pub. Date: Aug. 14, 2003

(54) Process for forming hydrogen silsesquioxane resins

(76) Inventors: Thomas A. Deis, Vista, CA (US); Stelian Grigoras, Midland, MI (US); Michael J. Spaulding, Esexville, MI (US)

Correspondence Address: WILLIAMS, MORGAN & AMERSON, P.C., 10333 RICHMOND, SUITE 1100, HOUSTON, TX, 77042, US

(21) Appl. No.: 10/060,558

(22) Filed: Jan. 30, 2002

(51) Int. Cl. B32B 9/04

(52) U.S. Cl. 428/447

(57) ABSTRACT

Herein disclosed is a method for preparing a siloxane resin comprising HSiO_{3/2} siloxane units and containing silicon-bonded hydroxy groups in a range from 1 to 40 mole percent, which comprises: (A) combining an alkoxysilane of the formula HSi(OR)₃ wherein R is selected from the group consisting of alkyl groups having 1 to 6 carbon atoms, water, an effective amount of an acid catalyst, and a first solvent, to form a reaction solution; and (B) reacting the reaction solution for a time and temperature sufficient to form the siloxane resin containing an alcohol. Also disclosed is a method for improving performance of a siloxane resin comprising HSiO_{3/2} siloxane units and containing silicon-bonded hydroxy groups in a range from about 1 mole percent to about 40 mole percent, comprising: (A) providing a siloxane resin solution comprising the siloxane resin, water, an acid catalyst, a first solvent, and an alcohol; (B) adding a second solvent having a boiling point higher than the first solvent; and (C) removing the water, acid catalyst, alcohol and first solvent. The resin produced by the disclosed method is useful in a method of forming an insoluble coating on a substrate, such as an electronic device.

### FIELD OF THE INVENTION

The present invention relates to dielectric coatings in semiconductor devices. More particularly, it relates to dielectric coatings formed from siloxane-based resins.

### BACKGROUND OF THE INVENTION

Semiconductor devices often have one or more arrays of patterned interconnect levels that serve to electrically couple the individual circuit elements forming an integrated circuit (IC). The interconnect levels are typically separated by an insulating or dielectric coating. Previously, a silicon oxide coating formed using chemical vapor deposition (CVD) or plasma enhanced techniques (PECVD) was the most commonly used material for such dielectric coatings.

Dielectric coatings formed from siloxane-based resins have found use because such coatings provide lower dielectric constants than CVD or PECVD silicon oxide coatings and also provide other benefits such as enhanced gap filling, surface planarization and have a high resistance to cracking. It is desirable for such siloxane-based resins to provide coatings by standard processing techniques such as spin coating.

In general, there are two types of dielectric coatings which serve as inter-layer dielectrics (ILD). The first type is a pre-metal dielectric material (PMD) formed before a metalization process is performed. The PMD serves as an insulating layer between the semiconductor component and the first metal layer. The second type of dielectric is an intermetal dielectric (IMD), which is a dielectric layer interposed between two metallic layers for insulation.

Semiconductor processes for manufacturing integrated circuits often require forming a protective layer, or layers, to reduce contamination by mobile ions, prevent unwanted dopant diffusion between different layers, and isolate elements of an integrated circuit.

Typically, such a protective layer is formed with silicon-based dielectrics, such as silicon dioxide, which may take the form of undoped silicate glass, borosilicate glass (BSG) or borophosphorous silicate glass (BPSG). If these dielectrics are disposed beneath the first metal layer of the integrated circuit, they are often referred to as pre-metal dielectrics.

Lee et al., “Application of HSQ (Hydrogen Silsesquioxane) Based SOG to Pre-Metal Dielectric Planarization in STC DRAM”, 1996 Symposium on VLSI Technology Digest of Technical Papers, describe a planarization process employing a flowable HSQ-based spin-on-glass for pre-metal dielectric. The HSQ film is capped with plasma enhanced oxide film (PE-Ox) before curing at 750° C. The PE-Ox film was not described. The cured film was less densified at the side walls of a patterned wafer. The films were reported to have no cracks.

Weiss et al., U.S. Pat. No. 4,999,397, describe a method for the preparation of a silane hydrolyzate composition which comprises adding trichlorosilane, water or hydrochloric acid, and a metal oxide to a non-sulfur containing polar organic solvent to form a reaction mixture, reacting the reaction mixture to form a silane hydrolyzate and a metal chloride. The metal chloride was then removed from the reaction mixture. The silane hydrolyzate composition is of the formula (RSi(OH)ₓO_{3-x/2})ₙ, wherein R is hydrogen or methyl, R is a least 50% hydrogen, n is an integer greater than about 8, and x is a number between 0 and 2, and wherein the silanol content in the silane hydrolyzate is from about 1 to 10 percent by weight. The silane hydrolyzate compositions are metastable in solvent but become insoluble after being coated on a substrate and subjected to an oxidizing atmosphere at a temperature between about 100° to 1000° C. to form ceramic or ceramic-like coatings on substrates.

Baney et al., EP Patent Application No. 0443760A2, describe a method for hydrolyzing hydridosilanes of the formula HSi(OR)₃ to form a soluble hydrolysate comprising a polymer having units of the formula HSi(OH)ₓ(OR)_{y}O_{z/2}). R is an organic group containing 1-6 carbon atoms, which when bonded to the silicon through an oxygen atom forms a hydrolyzable substituent, x=0-2, y=0-2, z=1-3 and x+y+z=3. Preferred hydrolyzable groups are alkoxy, with ethoxy being most preferred. The method comprises combining the hydridosilane, an oxygen containing polar organic solvent, water and an acid to form the soluble hydrolyzate. The hydrolyzates in the solvent are applied to a substrate, the solvent evaporated and the coating heated above 200° C. form a silica coating.

Haluska, U.S. Pat. No. 5,446,088, describes a method of co-hydrolyzing silanes of the formulas HSi(OR)₃ and Si(OR)₄ to form co-hydrolyzates useful in the formation of coatings. The R group is an organic group containing 1-20 carbon atoms, which when bonded to silicon through the oxygen atom, forms a hydrolyzable substituent. Especially preferred hydrolyzable groups are methoxy and ethoxy. The hydrolysis with water is carried out in an acidified oxygen containing polar solvent. The co-hydrolyzates in the solvent are applied to a substrate, the solvent evaporated and the coating heated at 50° to 1000° C. to convert the coating to silica.

Sakamoto et al., U.S. Pat. No. 5,762,697, describe a coating solution prepared by the hydrolysis of a trialkoxysilane in an alkyleneglycol dialkyl ether solvent by adding water and a catalytic amount of an acid followed by removal of the alcohol formed by the hydrolysis reaction of the trialkoxysilane such that the content of the alcohol in the coating solution does not exceed 10% by weight or, preferably, 3% by weight. The coating solution is applied to a silicon wafer by spin coating. The coated silicon wafer is heated at 80° C. for 1 minute, then at 150° C. for 1 minute, then at 200° C. for 1 minute, followed by heating in air at 400° C. for 30 minutes to convert the coated film into a silica-based film.

Sakamoto et al., U.S. Pat. No. 5,496,402, describe a coating solution prepared by the partial cohydrolysis-cocondensation product of silanes of the formulas HSi(OR)₃ and Si(OR)₄ in an organic solvent wherein R is an alkyl group having 1 to 4 carbon atoms or a phenyl group. The organic solvent is exemplified by monohydric alcohols, polyhydric alcohols, esters and ketones used singly or as a combination of two kinds or more. The partial cohydrolysis-cocondensation product in solvent is applied to a silicon wafer by spin coating, dried and the coated silicon wafer baked at 350° to 500° C. form a silica-based film.

However, a need remains for materials and processing methods that would allow the filling of very narrow gaps (less than about 1.0 μm) with aspect ratios (height/width) of 7 or more, in order to fill the requirements of the electronic industry. The high aspect ratio of the gaps limits the use of CVD methods, due to shadowing problems, and for that reason, spin-on methods are more promising. Desirably, the materials used in spin-on methods should allow the formation of thin films on the electronic substrate and the filling of gaps present on the wafer. Furthermore, after thermal curing is performed as part of the typical process spin-on process, the resulting material should desirably survive etching with hydrofluoric acid (HF) for at least about 90 sec.

Materials useful in spin-on methods consist of macromolecules that are dissolved in one solvent or a mixture of solvents. The structure and composition of the macromolecule and the solvent(s) control the quality of the thin film formed therefrom and the quality of the gap-filling process. The solvent evaporation rate, capillary and osmotic forces, and the packing of the macromolecules before cross-linking determine the properties of the final product. In addition, the temperature and atmosphere under which the process is performed are important factors in providing desirable properties.

A need remains for siloxane resins useful in the production of semiconductor devices, and methods for producing such resins. It is further desirable that such methods provide resins with improved storage stability and that coatings produced by curing the resins have increased ease of processing.

### SUMMARY OF THE INVENTION

This invention pertains to a method for preparing a soluble siloxane resin comprising HSiO_{3/2} siloxane units and containing silicon bonded hydroxy groups (H(OH)SiO_{2/2}) in a range from about 1 mole percent to about 40 mole percent. The method comprises combining an alkoxysilane of the formula HSi(OR)₃ wherein R is selected from the group consisting of alkyl groups having from 1 to about 6 carbon atoms, water, an acid catalyst, and a first solvent to form a reaction solution. This reaction solution is reacted for a time and temperature sufficient to form the soluble siloxane resin and an alcohol by-product. A second solvent having a boiling point higher than the first solvent is added to the reaction solution and the alcohol, remaining water, and first solvent are then removed.

This invention also pertains to a method of forming a coating on a substrate in which the substrate is coated with the above siloxane resin and the coated substrate is then heated to a temperature of between about 350° C. and about 1000° C.

In certain embodiments, this invention provides a method for making siloxane resins with improved storage stability and a method for curing these resins to produce coatings with increased ease of processing compared to previous methods for making hydridosiloxane resins. These coatings have the advantage that they may be formed using conventional coating processing such as spin coating.

### DETAILED DESCRIPTION OF THE INVENTION

The present invention pertains to a method for preparing a siloxane resin comprising HSiO_{3/2} siloxane units and containing silicon bonded hydroxy groups in a range from about 1 mole percent to about 40 mole percent, which comprises:

(A) combining an alkoxysilane of the formula HSi(OR)₃ wherein R is selected from the group consisting of alkyl groups having 1 to about 6 carbon atoms, water, a first solvent, and an effective amount of an acid catalyst to form a single phase reaction solution; and,

(B) reacting the reaction solution for a time and temperature sufficient to form a siloxane resin solution containing an alcohol.

In another embodiment, the present invention relates to a method for improving performance of a siloxane resin comprising HSiO_{3/2} siloxane units and containing silicon-bonded hydroxy groups in a range from about 1 mole percent to about 40 mole percent, comprising:

(A) providing a siloxane resin solution comprising the siloxane resin, water, an acid catalyst, a first solvent, and an alcohol;

(B) adding a second solvent having a boiling point higher than the first solvent to the siloxane resin solution; and

(C) removing the water, acid catalyst, alcohol and first solvent from the siloxane resin solution.

First, in reference to the siloxane resin, by “containing silicon bonded hydroxy groups in a range from about 1 mole percent to about 40 mole percent” is meant that from about 1 percent to about 40 percent of the silicon atoms in the siloxane resin have at least one bond to an —OH moiety.

The alkoxysilane has the formula HSi(OR)₃ wherein R is selected from the group consisting of alkyl groups having from 1 to about 6 carbon atoms. R can be linear, branched, or cyclic, and is exemplified by, but not limited to, alkyl groups such as methyl, ethyl, propyl, butyl, pentyl and hexyl. The R group is attached to a silicon atom through an oxygen atom (Si—OR) forming a silicon bonded alkoxy group which is a hydrolyzable group. By “hydrolyzable group” is meant that greater than about 95 mole percent of (OR) reacts with water (hydrolyzes) under the conditions of the reaction to effect formation of the siloxane resin. It is preferred that the alkoxysilane be trimethoxysilane or triethoxysilane because of their easy availability. It is more preferred that the alkoxysilane be trimethoxysilane.

Water is present in an amount to effect hydrolysis of the alkoxy group, (OR). Typically water is present in an amount from about 1 to about 5 moles of water per mole of (OR) in the alkoxysilane. It is preferred that the amount of water is from about 1.0 to about 1.5 moles per mole of (OR) in the alkoxysilane. However, any amount of water can be added, provided it is not so high that phase separation between the organic and aqueous components occurs.

The first solvent comprises an oxygen-containing polar organic solvent which is capable of dissolving the alkoxysilane and promoting hydrolysis and condensation. Desirably, the polar organic solvent can accept a significant amount of water without phase separation. The polar organic solvent is exemplified by, but not limited to, ethylene glycol dimethyl ether (GDME); 1,4-dioxane; tetrahydrofuran (THF); and alcohols having from 1 to about 6 carbon atoms, such as propanol, isopropanol (IPA), and butanol; among others. Preferred polar organic solvents are 1,4-dioxane, THF, and GDME. In addition, the first solvent may also be a mixture of two or more solvents.

The solvent or solvents are generally used in an amount which dilutes the alkoxysilanes to about 15 weight percent to about 40 weight percent of the reaction solution, and preferably to about 20 weight percent to about 30 weight percent of the reaction solution.

The acid catalyst is used to promote the hydrolysis and condensation of the alkoxysilane. Generally, most inorganic acids and some organic acids will function herein. Exemplary acids include, but are not limited to, hydrochloric acid, phosphoric acid, nitric acid, perchloric acid, sulfuric acid, carboxylic acid such as formic acid, acetic acid, propionic acid and butyric acid, or mixtures thereof. Nitric acid is preferred because of its volatility and ease of removal. Generally, the acid is used in an amount which will acidify the reaction solution (i.e. create a pH less than about 7). The amount of acid in the reaction solution is in the range from about 1 part per million (ppm) to about 10,000 ppm, with from about 10 ppm to about 1,000 ppm being preferred and from about 50 ppm to about 200 ppm being most preferred. Also useful as an acid catalyst is ozonolized water (ozone dissolved in water).

Combining the alkoxysilane, water, acid catalyst and first solvent may be done in any order to form the reaction solution. Generally the alkoxysilane is dissolved in the first solvent and then the acid and water added to the solution. The reaction usually occurs when the above components are combined. The temperature at which the reaction is carried out is not critical as long as it does not cause significant gelation or cause curing of the siloxane resin product. To increase the rate and extent of reaction, however, various facilitating measures such as temperature control and/or stirring are utilized. For example, stirring the mixture with the application of mild heat in the range of from about 25° C. to about 80° C. for from about 0.1 hr to about 48 hr will generally produce a desirable siloxane resin.

By being a single phase reaction solution, the reaction solution minimizes the tendency to gelation of the siloxane resin and subsequent undesirable increase in molecular weight.

After reaction, a second solvent having a boiling point higher than the first solvent is added to the reaction solution. The second solvent is a solvent which is capable of dissolving the siloxane resin. It is desirable that it is miscible with the first solvent. The second solvent is exemplified by, but not limited to, methyl isobutyl ketone (MIBK), 2-ethoxyethanol, propylene glycol methyl ether acetate (PGMEA), cyclohexanone, and 1,2-diethoxyethane, among others. MIBK is preferred.

Removal of alcohol, water, acid and at least a portion of the first solvent is carried out to improve the stability of the siloxane resin and to obtain good films for spin-on electronic coatings. By “removal” or “removing” is meant that the quantities of alcohol, water, acid, and first solvent in the reaction solution are lower after the removing step than they were before the removing step. Removal can be performed by heating the reaction solution to a temperature greater than the boiling point of the alcohol, water, and first solvent, but less than the boiling point of the second solvent; pressurizing or depressurizing the reaction solution; using an apparatus such as a Rotavap; or a combination thereof. In one preferred embodiment, removal is performed by a technique selected from the group consisting of rotary evaporation and distillation. Preferably, greater than about 90 wt % of each of alcohol, water, acid, and first solvent are removed by the removing step. More preferably, greater than about 95 wt % of each of alcohol, water, acid, and first solvent are removed by the removing step.

A portion of the second solvent may be removed from the reaction solution by the removing step. This is within the scope of the present invention. If desired, after the removing step, second solvent can be added, either to replace the portion, if any, of the second solvent removed in the removing step, or to increase the mass or volume of the reaction solution.

The structure of the siloxane resin is not specifically limited. The siloxane resin may be less than fully hydrolyzed, resulting in SiOR groups remaining in the resin. Typically, the resin contains less than about 10 mole % SiOR groups, preferably less than about 1 mole % SiOR groups. The siloxane resin may also contain less than about 10 mole % SiO_{4/2} units. In one preferred embodiment, the resin contains from about 5 mole % to about 20 mole % H(OH)SiO_{2/2} units.

In certain embodiments, the siloxane resin exhibits resistance to gelation in the presence of ammonium acetate. Most known siloxane resins gel rapidly in the presence of ammonium acetate, e.g., typically gel within about 5 min. In certain embodiments, siloxane resins produced according to the present method resist gelation, at room temperature in the presence of a 1% solution of ammonium acetate (100 ppm in methanol), in less than about 1 day, preferably less than about 2 days or longer. The use of trimethoxysilane as the alkoxysilane is preferred in the production of siloxane resins according to this embodiment of the invention.

The siloxane resin may be used to prepare an insoluble coating on a substrate. The method of forming such coatings generally comprises applying a solution of the resin to the surface of a substrate and then heating the coated substrate to a temperature from about 350° C. to about 1000° C. for a period of time sufficient to convert the siloxane resin into an insoluble silica coating. Preferably, the temperature is from about 600° C. to about 800° C.

The siloxane resin is typically applied to a substrate as a solvent dispersion wherein the solvent is the second solvent described above. Alternatively, if it is desired to have the siloxane resin in a particular solvent, additional solvents may be added or the second solvent may be replaced with another solvent. Solvents which may be used include any agent or mixture of agents which will dissolve or disperse the siloxane resin to form a homogeneous liquid mixture without affecting the resulting coating or the substrate. The solvent can generally be any organic solvent that does not contain functional groups, such as a hydroxy group, which may participate in a reaction with the siloxane resin exemplified by those discussed herein above for the reaction of the silane mixture with water. The solvent is present in an amount sufficient to dissolve the siloxane resin to the concentration desired for a particular application. Typically the solvent is present in an amount from about 40 weight percent to about 95 weight percent, preferably from about 70 weight percent to about 90 weight percent based on the weight of the siloxane resin and solvent.

Specific methods for application of the siloxane resin to a substrate include, but are not limited to, spin coating, dip coating, spray coating, flow coating, and screen printing, among others. The preferred method for application is spin coating. The solvent is allowed to evaporate from the coated substrate resulting in the deposition of the siloxane resin coating on the substrate. Any suitable means for evaporation may be used, such as simple air drying by exposure to an ambient environment, the application of a vacuum, or mild heat (up to about 50° C.). The evaporation can be performed prior to curing or during the early stages of the curing process. When spin coating is used, the additional drying method is minimized since the spinning drives off the solvent.

Following application to the substrate, the siloxane resin coating is heated for a time and temperature sufficient to effect cure of the siloxane resin, thereby forming an insoluble silica coating. Time periods in the range of a few seconds to several minutes for thin films (less than about 0.2 μm) to several hours for thick films (greater than about 1 μm), depending on the temperature, are generally useful herein. It is preferred to heat the coated substrate at a temperature of from about 600° C. to about 1000° C. for a time of about 10 min to about 2 hr. By “cured coating” is meant that the coating is converted to a coating that is essentially insoluble in the solvent from which the siloxane resin was deposited onto the substrate or any solvent delineated above as being useful for the application of the siloxane resin.

Heating may be conducted at any effective atmospheric pressure from vacuum to above atmospheric and under any effective oxidizing or non-oxidizing gaseous environment such as those comprising air, O₂, oxygen plasma, ozone, ammonia, amines, water vapor, N₂O, hydrogen, etc. It is preferred that heating is conducted in the presence of steam.

Any method of heating, such as the use of a quartz tube furnace, a convection oven, or radiant or microwave energy is generally functionally herein. Similarly, the rate of heating is generally not a critical factor, but it is most practical and preferred to heat the coated substrate as rapidly as possible.

The insoluble silica coatings produced herein may be produced on any substrate. However, the coatings are particularly useful on electronic substrates. The term “electronic substrate,” as used herein, includes silicon-based devices and gallium arsenide-based devices intended for use in the manufacture of a semiconductor component including focal plane arrays, opto-electronic devices, photovoltaic cells, optical devices, transistor-like devices, 3-D devices, silicon-on-insulator devices, super lattice devices, flat panel displays, and the like.

The siloxane resin can be applied to an electronic substrate to form a premetal dielectric (PMD) or an intermetal dielectric (IMD) layer. The siloxane resin is especially useful in forming a PMD layer. In the PMD layer case, the electronic substrate to which the siloxane resin can be applied can be bare (i.e., has not undergone passivation) or can have undergone primary passivation. Such primary passivation can involve the formation of ceramic coatings, such as silica, silicon nitride, silicon carbide, silicon oxynitride, silicon oxycarbide, PSG, and BPSG, among others. Primary passivation coatings and liners and methods for forming them are known to those skilled in the art.

By the above method an insoluble silica coating is produced on the substrate. Preferably the insoluble silica coatings have a thickness of from about 0.02 μm to about 2 μm. A thickness of from about 0.07 μm to about 0.8 μm is more preferred. The coating smoothes the irregular surfaces of the various substrates and has excellent adhesion properties. The density of the coating, defined as SiO per micron, obtainable from, e.g., a Fourier Transform Infrared Analyzer, is preferably in the range of about 50 to about 150.

Additional coatings may be applied over the insoluble silica coating if desired. These can include, for example SiO₂ coatings, silicon-containing coatings, silicon carbon-containing coatings, silicon nitrogen-containing coatings, silicon oxygen nitrogen-containing coatings, silicon nitrogen carbon-containing coatings, and diamond-like coatings produced from deposition (i.e. CVD, PECVD, etc.) of amorphous SiC:H, diamond, or silicon nitride. Methods for the application of such coatings are known in the art. Any method of applying an additional coating known in the art can be used, and such methods include, but are not limited to, chemical vapor deposition techniques such as thermal chemical vapor deposition (TCVD), photochemical vapor deposition, plasma enhanced chemical vapor deposition (PECVD), electron cyclotron resonance (ECR), and jet vapor deposition. The additional coatings can also be applied by physical vapor deposition techniques such as sputtering or electron beam evaporation. These processes involve either the addition of energy in the form of heat or plasma to a vaporized species to cause the desired reaction, or they focus energy on a solid sample of the material to cause its deposition.

The insoluble silica coatings formed by this method are particularly useful as coatings on electronic devices such as integrated circuits.

### EXAMPLES

The following non-limiting examples are provided so that one skilled in the art may more readily understand the invention. In the Examples weights are expressed as grams (g). Molecular weight is reported as number average molecular weight (MWn) and weight average molecular weight (MWw) determined by Gel Permeation Chromatography. Analysis of the siloxane resin composition was done using ²⁹Si nuclear magnetic resonance (NMR).

In the following examples, Me stands for methyl, Et stands for ethyl, MIBK stands for methylisobutylketone and DGME stands for ethylene glycol dimethyl ether.

### Example 1

This example illustrates the formation of a siloxane resin composition from trimethoxysilane in 1,4-dioxane. 25.2 g of trimethoxysilane were added to 200 g of 1,4 dioxane, in a plastic bottle with a magnetic stirrer. 11 g of deionized water containing 100 parts per million (ppm) of nitric acid was rapidly added to the trimethoxysilane/1,4-dioxane solution to form a reaction mixture. The reaction mixture was stirred for 8 hours at room temperature. Then, 150 g of MIBK were added to the reaction mixture and volatiles removed using a rotary evaporator under vacuum (10 to 20 mm Hg) at room temperature. Approximately 70-75% of the volatiles were removed (methanol, 1,4-dioxane, water and nitric acid) to leave 10 percent by weight of the siloxane resin in MIBK which was stored at −10° C. in a plastic bottle. Table 1 summarizes the siloxane resin synthesis. Analysis of the siloxane resin is shown in Table 2.

### Examples 2 to 8

Siloxane resins were prepared from trimethoxysilane or triethoxysilane using reagents shown in Table 1 and following Example 1. Analysis of the resulting siloxane resins is shown in Table 2.

TABLE 1
Summary of Resin Synthesis

| | Silane (g) | | Solvent (g) | | | Time |
|---|---|---|---|---|---|---|
| Example | HSi(OMe)₃ | HSi(OEt)₃ | Dioxane | DGME | H₂O (g) | (hrs) |
| 1 | 25.2 | | 200 | | 11 | 8 |
| 2 | 25.2 | | 400 | | 11 | 24 |
| 3 | 25.2 | | | 100 | 11 | 8 |
| 4 | 25.2 | | | 200 | 11 | 24 |
| 5 | | 44.6 | 136 | | 16.1 | 8 |
| 6 | | 45.0 | 285 | | 16.1 | 24 |
| 7 | | 44.6 | | 135 | 16.1 | 8 |
| 8 | | 44.6 | | 285 | 16.1 | 8 |

TABLE 2
Analysis of Resins

| | | | Molar Ratio of | | |
|---|---|---|---|---|---|
| | | Volatiles | SiH/SiOH | | |
| | | Removed | Based on ²⁹Si | | |
| Example | Yield | (%) | NMR | MWn | MWw |
| 1 | | 70-75 | 0.88/0.12 | 3750 | 8300 |
| 2 | | 75-80 | 0.89/0.11 | 2140 | 3460 |
| 3 | | 50-60 | 0.87/0.13 | 2285 | 3830 |
| 4 | | 65-75 | 0.88/0.12 | 1970 | 3060 |
| 5 | | 70-75 | 0.78/0.22 | 1230 | 1520 |
| 6 | | 60-70 | 0.72/0.22 | 1180 | 1400 |
| 7 | | 50-60 | 0.72/0.28 | 1230 | 1520 |
| 8 | | 70-75 | 0.72/0.28 | 1180 | 1400 |

### Example 9

A 1 g sample of the siloxane resin from Example 1 was applied to a patterned silicon wafer having a PECVD silicon nitride coating by spin coating at 2000 rpm for 20 sec. The coated wafer was put into a quartz tube furnace and purged with nitrogen for 30 min while heating to 700° C. at a rate of 25° C./min. Then the coated wafer was purged with a mixture of oxygen (O₂) and H₂O (steam) for 30 min while maintaining the temperature at 700° C., followed by removal of the steam purge and cooling to 100° C. while maintaining the O₂ purge. The O₂ purge was replaced with a nitrogen purge and the furnace cooled to room temperature. The coated wafer was covered with a layer of epoxy resin and a glass cover slide. The epoxy resin was cured for 15 min at 150° C. while exposing to air. The wafer was then polished using standard chemical mechanical polishing method with a colloidal silica solution and diamond grit polishing pads. The polished wafer was etched in a HF:H₂O (1:200 parts by weight) solution for 90 sec. The wafer was then analyzed with a Field Emission Scanning Electron Microscope to evaluate any damage produced by the HF:H₂O solution. The sample showed no significant damage after exposure to the HF:H₂O solution as evidenced by a uniform gray area indicating complete coverage with no corroded areas.

To evaluate film quality, the experiment was repeated using unpatterned (bare) wafers. Half of the wafer was exposed to the HF solution and the thickness difference between the etched and the unetched films allowed evaluation of the etch rates. The thickness, refractive index, SiO content, and etch rate are given in Table 3.

### Example 10

One gram of each of the siloxane resins from Examples 2-8 were applied to a patterned silicon wafer and evaluated as described in Example 9. The samples showed no significant damage after exposure to the HF:H₂O solution as evidenced by a uniform gray area indicating complete coverage with no corroded areas. The thickness, refractive index, SiO content, and etch rate are given in Table 3. The samples prepared on patterned wafers showed significant damage for the materials described by Examples 2-7. The material described by Example 8 did not show significant damage when it was applied in the gap. The samples were tested under similar conditions, without solvent transfer to MIBK. None survived in the gap after exposure to the HF solution for 90 sec.

### Example 11 (Comparative)

A 1 g sample of a hydrogen silsesquioxane resin prepared by the method of Collins et al., U.S. Pat. No. 3,615,272 and dissolved in MIBK was applied to a patterned silicon wafer and evaluated as described in Example 9. The sample showed considerable damage after exposure to the HF:H₂O solution as evidenced by a partial gray area with several dark black areas indicating corrosion of the coating, especially in the gap areas of the patterned wafer. The thickness, refractive index, SiO content, and etch rate are given in Table 3.

TABLE 3
Thin Film Properties on Silicon Wafers

| | Thickness | | SiO Content | Etch rate |
|---|---|---|---|---|
| Example | (Å) | RI | (SiO/μm) | (Å/s) |
| 1 | 1859 | 1.439 | 123 | 33 |
| 2 | 1957 | 1.442 | 144 | 26 |
| 3 | 1755 | 1.443 | 110 | 29 |
| 4 | 1670 | 1.446 | 116 | 25 |
| 5 | 2047 | 1.442 | 102 | 28 |
| 6 | 2220 | 1.441 | 100 | 27 |
| 7 | 2002 | 1.442 | 105 | 26 |
| 8 | 2021 | 1.443 | 113 | 25 |
| C-11 | 2846 | 1.436 | 99 | 29 |

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

What is claimed is:

1. A method for preparing a siloxane resin comprising HSiO_{3/2} siloxane units and containing silicon-bonded hydroxy groups in a range from about 1 mole percent to about 40 mole percent, comprising:
(A) combining an alkoxysilane of the formula HSi(OR)₃ wherein R is selected from the group consisting of alkyl groups having 1 to about 6 carbon atoms, water, an effective amount of an acid catalyst, and a first solvent, to form a single phase reaction solution; and,
(B) reacting the reaction solution for a time and temperature sufficient to form a siloxane resin solution containing an alcohol.

2. A method for improving performance of a siloxane resin comprising HSiO_{3/2} siloxane units and containing silicon-bonded hydroxy groups in a range from about 1 mole percent to about 40 mole percent, comprising:
(A) providing a siloxane resin solution comprising the siloxane resin, water, an acid catalyst, a first solvent, and an alcohol;
(B) adding a second solvent having a boiling point higher than the first solvent to the siloxane resin solution; and
(C) removing the water, acid catalyst, alcohol and first solvent from the siloxane resin solution.

3. The method of claim 1, wherein R is methyl.

4. The method of claim 1, wherein the acid catalyst is selected from the group consisting of nitric acid, perchloric acid, and ozonolized water.

5. The method of claim 1, wherein the first solvent is selected from the group consisting of ethylene glycol dimethyl ether (GDME), 1,4-dioxane, tetrahydrofuran (THF), propanol, isopropanol, and butanol.

6. The method of claim 1, wherein the reacting step is performed at from about 25° C. to about 80° C. for from about 0.1 hr to about 48 hr.

7. The method of claim 2, wherein the second solvent is selected from the group consisting of methyl isobutyl ketone (MIBK), 2-ethoxyethanol, propylene glycol methyl ether acetate (PGMEA), cyclohexanone, and 1,2-diethoxyethane.

8. The method of claim 2, wherein the water, acid catalyst, alcohol and first solvent are removed by a technique selected from the group consisting of rotary evaporation and distillation.

9. A siloxane resin formed by the method of claim 1, wherein the siloxane resin resists gelation in the presence of ammonium acetate for at least 1 day.

10. A method of forming an insoluble coating on a substrate, comprising:
(A) coating the substrate with a siloxane resin comprising HSiO_{3/2} siloxane units and containing silicon-bonded hydroxy groups in a range from about 1 mole percent to about 40 mole percent, to form a siloxane resin coating on the substrate;
(B) heating the coated substrate to a temperature from about 600° C. to about 1000° C. for a period of time sufficient to convert the siloxane resin coating into an insoluble coating.

11. The method of claim 10, wherein the insoluble coating has a thickness of from about 0.02 μm to about 2 μm.

12. The method of claim 10, wherein the resin is made by (A) combining an alkoxysilane of the formula HSi(OR)₃ wherein R is selected from the group consisting of alkyl groups having 1 to about 6 carbon atoms, water, an effective amount of an acid catalyst, and a first solvent, to form a reaction solution; (B) reacting the reaction solution for a time and temperature sufficient to form the siloxane resin containing an alcohol; (C) adding a second solvent having a boiling point higher than the first solvent; and (D) removing the water, acid catalyst, alcohol and first solvent.

13. The method of claim 12, wherein R is methyl.

14. The method of claim 12, wherein the acid catalyst is selected from the group consisting of nitric acid, perchloric acid, and ozonolized water.

15. The method of claim 12, wherein the first solvent is selected from the group consisting of ethylene glycol dimethyl ether (GDME), 1,4-dioxane, tetrahydrofuran (THF), propanol, isopropanol, and butanol.

16. The method of claim 12, wherein the reacting step is performed at from about 25° C. to about 80° C. for from about 0.1 hr to about 48 hr.

17. The method of claim 12, wherein the second solvent is selected from the group consisting of methyl isobutyl ketone (MIBK), 2-ethoxyethanol, propylene glycol methyl ether acetate (PGMEA), cyclohexanone, and 1,2-diethoxyethane.

18. The method of claim 12, wherein the water, acid catalyst, alcohol and first solvent are removed by a technique selected from the group consisting of rotary evaporation and distillation.

19. An electronic substrate coated by the method of claim 10.
